(19) United States
(12) Patent Application Publication
(10) Pub. No.: US 2013/0140886 A1
(43) Pub. Date: Jun. 6, 2013

(54) CONTROL SYSTEM FOR PARALLEL BATTERY CONNECTION CIRCUIT

(71) Applicant: Seiji Bito, Shizuoka (JP)

(72) Inventor: Seiji Bito, Shizuoka (JP)

(73) Assignee: SUZUKI MOTOR CORPORATION, Hamamatsu-shi, Shizuoka (JP)

(21) Appl. No.: 13/700,212

(22) PCT Filed: Apr. 27, 2011
(86) PCT No.: PCT/JP2011/060223

§ 371 Date: Feb. 11, 2013

(30) Foreign Application Priority Data
May 28, 2010 (JP) 2010-122578

(51) Int. Cl. B60L 11/18

(52) U.S. Cl. CPC B60L 11/1864; B60L 11/1874
USPC 307/10.7

(57) ABSTRACT

A control system for a parallel battery connection circuit has a plurality of secondary battery packs connected in parallel to each other, in which small batteries are combined and provided substantially equivalently to each other. The control system performs abnormality detection by detecting and comparing states of the secondary battery packs. The control system has state detecting circuits and a control circuit. The state detecting circuits detect currents or temperatures and are provided respectively in the secondary battery packs. The control circuit performs current limitation based on a magnitude of deviation between a deviation in either of a comparison of currents detected corresponding to the secondary battery packs by the state detecting circuits or a comparison of temperatures detected corresponding to the secondary battery packs by the state detecting circuits, and a predetermined judgment value.

### TECHNICAL FIELD

The present invention relates to a control system for a parallel battery connection circuit. More particularly, the present invention relates to an electrically powered vehicle having a battery as a driving energy source, such as an electric vehicle (also called “EV”), a hybrid vehicle (also called “HEV”), or a plug-in hybrid vehicle (also called “PHEV”). The present invention also relates to a method for detecting abnormality of a battery and a control circuit which performs this method.

### BACKGROUND ART

An electric vehicle, a hybrid vehicle, or a plug-in hybrid vehicle conventionally has a battery, a state detecting circuit which is a circuit detecting the state of this battery, an inverter, a driving motor, and a control circuit which is an EV controller controlling the power and driving force of these devices. The control circuit limits a current consumed by the inverter and the driving motor with respect to the battery and/or current generated by the inverter and the driving motor with respect to the battery by complying with a current limitation value communicated and outputted to the control circuit by the state detecting circuit, to thereby perform control to prevent overcharging and overdischarging of the battery.

### CITATION LIST

### Patent Literature

Patent Literature 1: Japanese Patent No. 4057193

### SUMMARY OF INVENTION

### Technical Problem

Incidentally, conventionally the battery is of one series connection type, and it is rare to use a plurality of parallel batteries as the battery.

In recent years, small battery cells are becoming popular, and while a capacity is secured by combining assembled current packs of small battery cells and connecting a plurality of them in parallel, the design flexibility of a battery unit is enlarged in a structure for mounting.

However, there is a disadvantage that detection of abnormality such as internal short-circuit, deterioration, overdischarging and overcharging of the plurality of battery packs connected in parallel is affected by environmental temperatures, and reliable judgment of abnormality is difficult.

For example, in one disclosed in the above Patent Document 1, although overcharging and overdischarging are judged by comparing battery temperatures, it is difficult to judge internal short-circuit and abnormality of deterioration.

It is an object of the present invention to prevent overcharging and overdischarging, and to further judge abnormality including deterioration and internal short-circuit accurately.

### Solution to Problem

Accordingly, in the present invention, in order to eliminate the above-described disadvantages, a control system for a parallel battery connection circuit having a plurality of secondary battery packs connected in parallel to each other, in which small batteries are combined and provided substantially equivalently to each other, and performing abnormality detection by detecting and comparing states of the secondary battery packs, includes: state detecting circuits which detect currents or temperatures and are provided respectively in the secondary battery packs; and a control circuit of the control system which performs current limitation based on a magnitude of deviation between a deviation in either of a comparison of currents detected corresponding to the secondary battery packs by the state detecting circuits or a comparison of temperatures detected corresponding to the secondary battery packs by the state detecting circuits, and a predetermined judgment value.

Further, a control system for a parallel battery connection circuit having a plurality of secondary battery packs connected in parallel to each other, in which small batteries are combined and provided substantially equivalently to each other, and performing abnormality detection by detecting and comparing states of the secondary battery packs, includes: state detecting circuits which detect currents and temperatures and are provided respectively in the secondary battery packs; and a control circuit of the control system which calculates a current ratio from currents detected corresponding to the secondary battery packs by the state detecting circuits and calculates a temperature deviation in a comparison of temperatures detected corresponding to the secondary battery packs by the state detecting circuits, and performs current limitation by comparing the calculated current ratio with a judgment value for the current ratio determined from the calculated temperature deviation.

### ADVANTAGEOUS EFFECTS OF INVENTION

As described in detail above, according to the present invention, a control system for a parallel battery connection circuit having a plurality of secondary battery packs connected in parallel to each other, in which small batteries are combined and provided substantially equivalently to each other, and performing abnormality detection by detecting and comparing states of the secondary battery packs, includes: state detecting circuits which detect currents or temperatures and are provided respectively in the secondary battery packs; and a control circuit which performs current limitation based on a magnitude of deviation between a deviation in either of a comparison of currents detected corresponding to the secondary battery packs by the state detecting circuits or a comparison of temperatures detected corresponding to the secondary battery packs by the state detecting circuits, and a predetermined judgment value.

Therefore, abnormality can be detected from a temperature difference and/or a current difference of the secondary battery packs, so as to prevent overdischarging and overcharging.

Further, a control system for a parallel battery connection circuit having a plurality of secondary battery packs connected in parallel to each other, in which small batteries are combined and provided substantially equivalently to each other, and performing abnormality detection by detecting and comparing states of the secondary battery packs, includes: state detecting circuits which detect currents and temperatures and are provided respectively in the secondary battery packs; and a control circuit which calculates a current ratio from currents detected corresponding to the secondary battery packs by the state detecting circuits and calculates a temperature deviation in a comparison of temperatures detected corresponding to the secondary battery packs by the state detecting circuits, and performs current limitation by comparing the calculated current ratio with a judgment value for the current ratio determined from the calculated temperature deviation.

Therefore, abnormality can be detected from a temperature difference and a current ratio, so as to prevent overdischarging and overcharging.

Further, presence of abnormality regarding overdischarging, overcharging, deterioration, and internal short-circuit of the secondary battery packs can be detected, and a secondary battery pack having abnormality can be identified.

### BRIEF DESCRIPTION OF DRAWINGS

FIG. 1 is a control flowchart of a control system for a parallel battery connection circuit illustrating a first embodiment (Embodiment 1).

FIG. 2 is a system structure diagram of the control system for the parallel battery connection circuit (Embodiment 1).

FIG. 3 is a control flowchart of a control system for a parallel battery connection circuit illustrating a second embodiment (Embodiment 2).

FIG. 4 is a control flowchart of a control system for a parallel battery connection circuit illustrating a third embodiment (Embodiment 3).

FIG. 5 is a diagram illustrating the relation between a battery temperature and a battery internal resistance (Embodiment 3).

FIG. 6 is a schematic circuit diagram of a parallel battery (Embodiment 3).

FIG. 7 is a diagram illustrating a judgment criterion with a battery temperature difference and a current ratio (Embodiment 3).

### DESCRIPTION OF EMBODIMENTS

Hereinafter, embodiments of the present invention will be described in detail based on the drawings.

### Embodiment 1

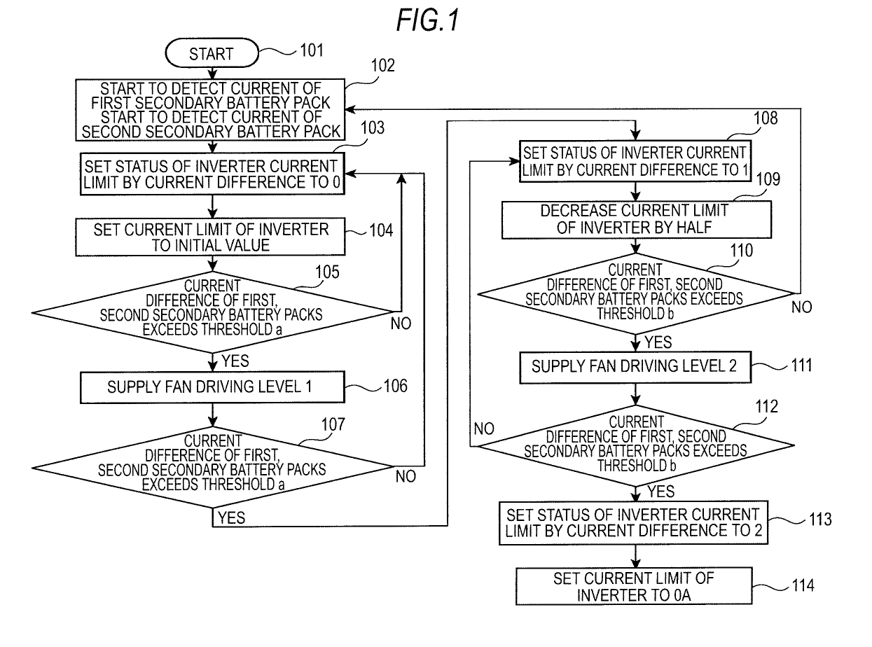

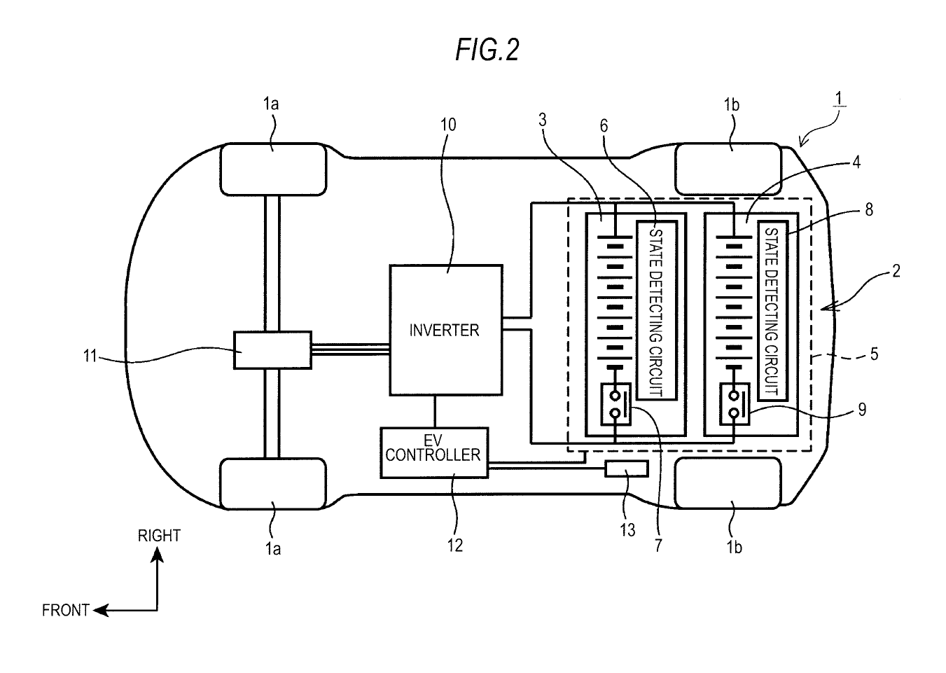

FIG. 1 and FIG. 2 are diagrams illustrating first embodiment of the present invention.

In FIG. 2, 1 denotes a vehicle and 2 denotes a control system for a parallel battery connection circuit mounted in the vehicle 1.

The control system 2 for the parallel battery connection circuit has a plurality of, for example two, first and second secondary battery packs 3, 4 connected in parallel to each other, in which small batteries are combined and provided substantially equivalently to each other, and performs abnormality detection by detecting and comparing states of the first and second secondary battery packs 3, 4.

Specifically, as illustrated in FIG. 2, small batteries (also called “small battery cells”) are combined and connected in series to provide the two, first and second secondary battery packs 3, 4, and these first and second secondary battery packs 3, 4 are connected in parallel to form a battery unit 5.

At this moment, the first secondary battery pack 3 is provided with a first state detecting circuit 6 which detects currents or temperatures (currents in this first embodiment) and a first relay 7.

Further, the second secondary battery pack 4 is provided with a second state detecting circuit 8 which detects currents or temperatures (currents in this first embodiment) and a second relay 9.

That is, in the battery unit 5 of the control system 2 of the parallel battery connection circuit, the small batteries are connected in series, and the first and second state detecting circuits 6, 8 and the first and second relays 7, 9 are mounted to form the first and second secondary battery packs 3, 4, respectively.

These two, first and second secondary battery packs 3, 4, a cooling fan (not illustrated), and so on are called generically as a “battery unit 5”.

Then, the control system 2 for the parallel battery connection circuit includes the battery unit 5, the first and second state detecting circuits 6, 8 which detect the currents of the first and second secondary battery packs 3, 4, an inverter 10, a driving motor 11, and a control circuit (also called “EV controller”) 12 which controls the power and driving force of these devices.

Here, as illustrated in FIG. 2, the battery unit 5 is disposed between rear wheels 1b, 1b of the vehicle 1. Further, on a vehicle front side of this battery unit 5, the inverter 10 and the control circuit 12 connected separately to the battery unit 5 are disposed. Moreover, between front wheels 1a, 1a of the vehicle 1, the driving motor 11 connected to the inverter 10 is disposed.

Further, the control circuit 12 has a structure to perform current limitation based on a magnitude of deviation between a deviation in a comparison of currents detected corresponding to the first and second secondary battery packs 3, 4 by the first and second state detecting circuits 6, 8 and a predetermined judgment value.

Describing more specifically, the control circuit 12 limits the current consumed by the inverter 10 and the driving motor 11 with respect to the battery unit 5.

Then, the control circuit 12 limits the current generated by the inverter 10 and the driving motor 11 with respect to the battery unit 5.

Therefore, the control circuit 12 detects abnormality from the current difference of the first and second secondary battery packs 3, 4 from each other to prevent overdischarging and overcharging.

Moreover, the control system 2 for the parallel battery connection circuit is provided with a supply fan 13 which cools the first and second secondary battery packs 3, 4. The control circuit 12 drives the supply fan 13 accompanying the judgment of the magnitude of deviation.

That is, the supply fan 13 mainly cools the numerous small batteries in the first and second secondary battery packs 3, 4 from the outside.

At this time, although not illustrated in detail, one supply fan 13 is provided in common to the first and second secondary battery packs 3, 4, by which the first and second secondary battery packs 3, 4 can be cooled uniformly by distributing and merging air flows by fan ducts (not illustrated).

Therefore, in the control system 2 for the parallel battery connection circuit, the influence of environmental temperatures which vary easily by a mounting structure, arrangement, and the like of the first and second secondary battery packs 3, 4 is reduced, thereby enabling prevention of overdischarging and overcharging.

Moreover, a status level is set for the current limitation, and the control circuit 12 changes the driving level of the supply fan 13 according to the status level of the current limitation.

At this time, as the number of the status level increases (in other words, “its depth increases”), it indicates that the status is getting worse such that status level “0” indicates a status within a usual normal range, status level “1” indicates a weak abnormality status, and status level “2” indicates a strong abnormality status.

Then, the current limitation also changes according to the number of the status level, and a limitation width also increases as the number increases.

Therefore, accuracy can be increased gradually according to the degree of the status.

Note that it is structured that the limitation width of the current limitation increases gradually as the status level of abnormality detection increases, and thus traveling is allowed for some time while being subjected to current limitation, thereby enabling retreat traveling (limp home traveling) and meanwhile allowing to achieve it together with protection of the battery unit 5.

In addition, the control circuit 12 receives the currents detected by the first and second state detecting circuits 6, 8 of the first and second secondary battery packs 3, 4 during traveling.

Then, the control circuit 12 calculates a current difference of the first and second secondary battery packs 3, 4 and, when the current difference exceeds the predetermined judgment value, increments the status of limiting a driving current of the inverter 10 by complying with an inverter current limitation map by battery current difference during traveling, as illustrated in [Table 1] below, and the control circuit 12 limits the current of the inverter 10 by complying with this limitation.

TABLE 1
Inverter current limitation map by battery
current difference during traveling

| Status | 0 | 1 | 2 |
|---|---|---|---|
| Judgment value | a | b | c |
| of ΔI(A) | | | |
| Current | Comply with battery 1 | Half of battery 1 | Stop |
| limitation | current limitation | current limitation | |
| | and battery 2 | and battery 2 | |
| | current limitation | current limitation | |

In the table, a<b<c holds true.

For example, a=50 (A), b=75 (A), and c=100 (A), or the like. The “comply with battery 1 current limitation and battery 2 current limitation” described in Table 1 means to set a predetermined limit value set in advance by the control circuit 12.

Further, the control circuit 12 receives error information from the first and second state detecting circuits 6, 8 of the first and second secondary battery packs 3, 4. Then, when it is judged that one of the secondary battery packs has failed, the control circuit 12 turns on the relay of the normal secondary battery pack to allow the limp home traveling.

That is, just after starting the current limitation, the control system 2 for the parallel battery connection circuit starts to measure currents of the first and second secondary battery packs 3, 4 and sets the inverter current limitation to an initial value (maximum) at the status level “0” (see Table 1).

Then, the control system 2 for the parallel battery connection circuit calculates the difference between the measured currents, and makes a comparison to see whether this current difference exceeds a predetermined judgment value, for example a threshold a.

When the current difference does not exceed the threshold a in this comparison, the control system 2 for the parallel battery connection circuit maintains the status level to “0” or, when the current difference exceeds the threshold a, drives the supply fan 13 at the driving level “1” (weak).

The control system 2 for the parallel battery connection circuit compares again the current difference with the threshold a and, when the current difference exceeds the threshold a, sets the status level to “1”, making the inverter current limitation be half of the initial value.

Thereafter, the control system 2 for the parallel battery connection circuit calculates the difference between the currents measured by the first and second secondary battery packs 3, 4, and makes a comparison to see whether this current difference exceeds a threshold b.

When the current difference does not exceed the threshold b in this comparison, the control system 2 for the parallel battery connection circuit returns the status level to “0” or, when the current difference exceeds the threshold b, drives the supply fan 13 at the driving level “2” (strong).

The control system 2 for the parallel battery connection circuit compares again the current difference with the threshold b and, when the current difference exceeds the threshold b, sets the status level to “2”, so as to limit the current completely (0A).

Next, operation will be described along a control flowchart of the control system 2 for the parallel battery connection circuit of FIG. 1.

First, the control circuit 12 of the control system 2 for the parallel battery connection circuit executes a control program to start the control flowchart (101), thereby starting the current limitation.

First, the control circuit 12 starts to detect the current of the first secondary battery pack 3 and starts to detect the current of the second secondary battery pack 4 via the first and second state detecting circuits 6, 8 (102).

Next, the control circuit 12 sets the status level of the inverter current limitation by current difference to “0” (103).

Next, the control circuit 12 sets the current limitation of the inverter 10 to an initial value (104).

Next, the control circuit 12 determines whether or not the current difference of the first and second secondary battery packs 3, 4 exceeds the predetermined judgment value, for example the threshold a (105).

When this determination (105) is NO, the control circuit 12 returns to the above-described processing (103) and sets the status level of the inverter current limitation by current difference to “0” (103).

On the other hand, when the determination (105) is YES, the control circuit 12 sets the driving level of the supply fan 13 to “1” (106).

After the processing (106) of setting the driving level of the supply fan 13 to “1”, the control circuit 12 determines whether or not the current difference of the first and second secondary battery packs 3, 4 exceeds the predetermined judgment value, for example the threshold a (107).

When this determination (107) is NO, the control circuit 12 returns to the above-described processing (103) and sets the status level of the inverter current limitation by current difference to “0” (103).

On the other hand, when the determination (107) is YES, the control circuit 12 sets the status level of the inverter current limitation by current difference to “1” (108).

Next, the control circuit 12 decreases the current limitation of the inverter 10 by half (109).

Next, the control circuit 12 determines whether or not the current difference of the first and second secondary battery packs 3, 4 exceeds the predetermined judgment value, for example the threshold b (110).

When this determination (110) is NO, the control circuit 12 returns to the above-described processing (102) and starts to detect the currents of the first and second secondary battery packs 3, 4 via the first and second state detecting circuits 6, 8 (102).

On the other hand, when the determination (110) is YES, the control circuit 12 sets the driving level of the supply fan 13 to “2” (111).

After the processing (111) of setting the driving level of the supply fan 13 to “2”, the control circuit 12 determines whether or not the current difference of the first and second secondary battery packs 3, 4 exceeds the predetermined judgment value, for example the threshold b (112).

When this determination (112) is NO, the control circuit 12 returns to the above-described processing (108), and sets the status level of the inverter current limitation by current difference to “1” (108).

On the other hand, when the determination (112) is YES, the control circuit 12 sets the status level of the inverter current limitation by current difference to “2” (113).

Next, the control circuit 12 sets the current limitation of the inverter 10 to “0A” (114).

### Embodiment 2

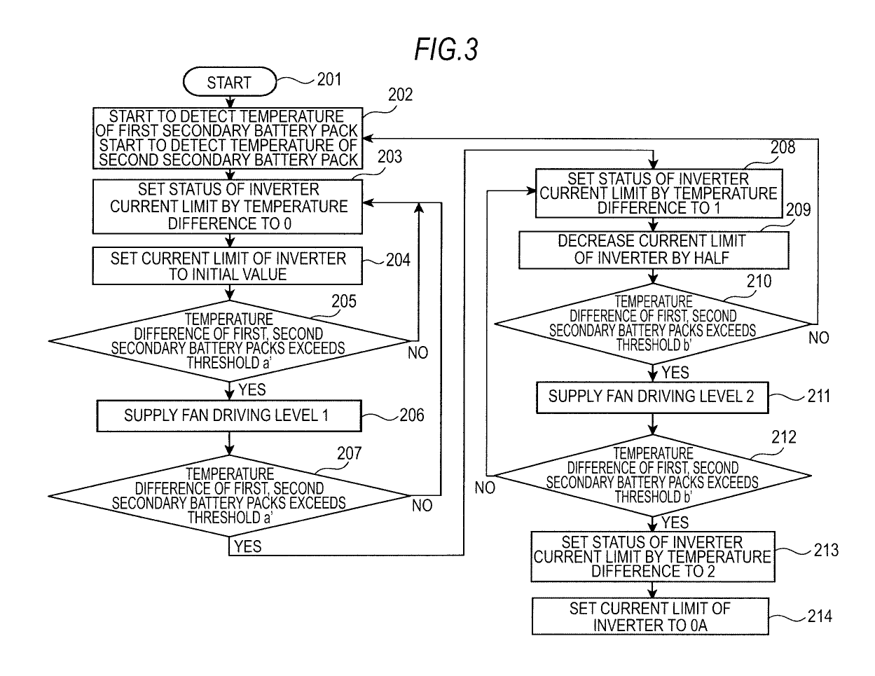

FIG. 3 illustrates a second embodiment of the present invention.

In this second embodiment, components having the same function as those of the above-described first embodiment are denoted by the same numerals and described.

This second embodiment is characterized in a structure such that the control circuit 12 performs current limitation based on a magnitude of deviation between a deviation in a comparison of temperatures detected corresponding to the first and second secondary battery packs 3, 4 by the first and second state detecting circuits 6, 8 and a predetermined judgment value.

Specifically, the control circuit 12 receives temperatures detected by the first and second state detecting circuits 6, 8 of the first and second secondary battery packs 3, 4 during traveling.

The control circuit 12 calculates a temperature difference of the first and second secondary battery packs 3, 4 and, when the temperature difference exceeds a predetermined judgment value, increments the status of limiting the driving current of the inverter 10 by complying with an inverter current limitation map by battery temperature difference during traveling which is illustrated in [Table 2] below, and the control circuit 12 limits the current of the inverter 10 by complying with this limitation.

TABLE 2
Inverter current limitation map by battery
temperature difference during traveling

| Status | 0 | 1 | 2 |
|---|---|---|---|
| Judgment value | a′ | b′ | c′ |
| of ΔT(° C.) | | | |
| Current | Comply with battery 1 | Half of battery 1 | Stop |
| limitation | current limitation | current limitation | |
| | and battery 2 | and battery 2 | |
| | current limitation | current limitation | |

In the table, a′<b′<c′ holds true.

For example, a′=10 (° C.), b′=15 (° C.), and c′=(° C.), or the like. The “comply with battery 1 current limitation and battery 2 current limitation” described in Table 2 means to set a predetermined limit value set in advance by the control circuit 12.

Therefore, the control circuit 12 detects abnormality from the temperature difference of the first and second secondary battery packs 3, 4 to prevent overdischarging and overcharging.

Note that in order not to be affected by environmental temperatures, a structure to cool the batteries (3, 4) by a certain amount of coolant is also possible.

In the second embodiment, similarly to the above-described first embodiment, a supply fan 13 which cools the first and second secondary battery packs 3, 4 is provided in the control system 2 for the parallel battery connection circuit. The control circuit 12 drives the supply fan 13 according to judgment of the magnitude of deviation.

Therefore, in the control system 2 for the parallel battery connection circuit, the influence of environmental temperatures which vary easily by a mounting structure, arrangement, and the like of the first and second secondary battery packs 3, 4 is reduced, thereby enabling prevention of overdischarging and overcharging.

Moreover, in the second embodiment, similarly to the first embodiment, a status level is set for the current limitation, and the control circuit 12 changes the driving level of the supply fan 13 according to the status level of the current limitation.

Therefore, the control circuit 12 can increase accuracy gradually according to the degree of the status.

That is, just after starting the current limitation, the control system 2 for the parallel battery connection circuit starts to measure temperatures of the first and second secondary battery packs 3, 4 and sets the inverter current limitation to an initial value (maximum) at the status level “0” (see Table 2).

Then, the control system 2 for the parallel battery connection circuit calculates the difference between the measured temperatures, and makes a comparison to see whether this temperature difference exceeds a predetermined judgment value, for example a threshold a′.

When the temperature difference does not exceed the threshold a′ in this comparison, the control system 2 for the parallel battery connection circuit maintains the status level to “0” or, when the temperature difference exceeds the threshold a′, drives the supply fan 13 at the driving level “1” (weak).

The control system 2 for the parallel battery connection circuit compares again the temperature difference with the threshold a′ and, when the temperature difference exceeds the threshold a′, sets the status level to “1”, making the inverter current limitation be half of the initial value.

Thereafter, the control system 2 for the parallel battery connection circuit calculates the difference between the measured temperatures, and makes a comparison to see whether this temperature difference exceeds a threshold b′.

When the temperature difference does not exceed the threshold b′ in this comparison, the control system 2 for the parallel battery connection circuit returns the status level to “0” or, when the temperature difference exceeds the threshold b′, drives the supply fan 13 at the driving level “2” (strong).

The control system 2 for the parallel battery connection circuit compares again the temperature difference with the threshold b′ and, when the temperature difference exceeds the threshold b′, sets the status level to “2”, so as to limit the current completely (0A).

Next, operation will be described along a control flowchart of the control system 2 for the parallel battery connection circuit of FIG. 3.

First, the control circuit 12 of the control system 2 for the parallel battery connection circuit executes a control program to start the control flowchart (201), thereby starting the current limitation.

First, the control circuit 12 starts to detect the temperature of the first secondary battery pack 3 and starts to detect the temperature of the second secondary battery pack 4 via the first and second state detecting circuits 6, 8 (202).

Next, the control circuit 12 sets the status level of the inverter current limitation by temperature difference to “0” (203).

Next, the control circuit 12 sets the current limitation of the inverter 10 to an initial value (204).

Next, the control circuit 12 determines whether or not the temperature difference of the first and second secondary battery packs 3, 4 exceeds the predetermined judgment value, for example the threshold a′ (205).

When this determination (205) is NO, the control circuit 12 returns to the above-described processing (203) and sets the status level of the inverter current limitation by temperature difference to “0” (203).

On the other hand, when the determination (205) is YES, the control circuit 12 sets the driving level of the supply fan 13 to “1” (206).

After the processing (206) of setting the driving level of the supply fan 13 to “1”, the control circuit 12 determines whether or not the temperature difference of the first and second secondary battery packs 3, 4 exceeds the predetermined judgment value, for example the threshold a′ (207).

When this determination (207) is NO, the control circuit 12 returns to the above-described processing (203) and sets the status level of the inverter current limitation by temperature difference to “0” (203).

On the other hand, when the determination (207) is YES, the control circuit 12 sets the status level of the inverter current limitation by temperature difference to “1” (208).

Next, the control circuit 12 decreases the current limitation of the inverter by half (209).

Next, the control circuit 12 determines whether or not the temperature difference of the first and second secondary battery packs 3, 4 exceeds the predetermined judgment value, for example the threshold b′ (210).

When this determination (210) is NO, the control circuit 12 returns to the above-described processing (202) and starts to detect the temperatures of the first and second secondary battery packs 3, 4 via the first and second state detecting circuits 6, 8 (202).

On the other hand, when the determination (210) is YES, the control circuit 12 sets the driving level of the supply fan 13 to “2” (211).

After the processing (211) of setting the driving level of the supply fan 13 to “2”, the control circuit 12 determines whether or not the temperature difference of the first and second secondary battery packs 3, 4 exceeds the predetermined judgment value, for example the threshold b′ (212).

When this determination (212) is NO, the control circuit 12 returns to the above-described processing (208), and sets the status level of the inverter current limitation by temperature difference to “1” (208).

On the other hand, when the determination (212) is YES, the control circuit 12 sets the status level of the inverter current limitation by temperature difference to “2” (213).

Next, the control circuit 12 sets the current limitation of the inverter 10 to “0A” (214).

### Embodiment 3

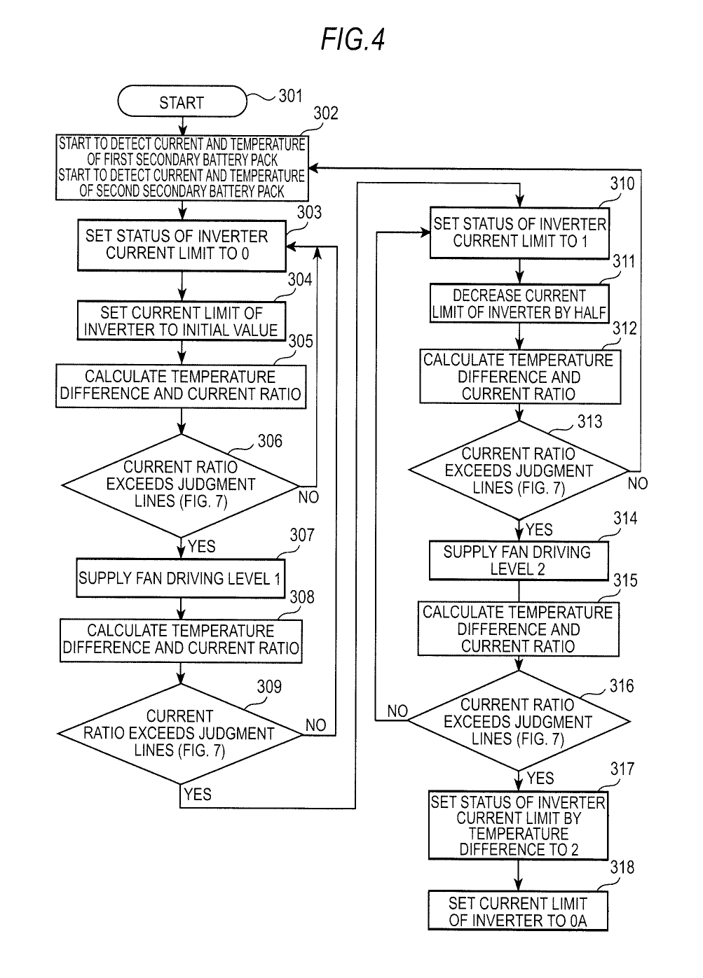

FIG. 4 to FIG. 7 illustrate a third embodiment of the present invention.

This third embodiment is characterized in a structure such that current limitation is performed with currents and temperatures detected from the first and second secondary battery packs 3, 4 by the first and second state detecting circuits 6, 8.

Specifically, in the control system 2 for the parallel battery connection circuit, the control circuit 12 calculates a current ratio from currents detected corresponding to the secondary battery packs 3, 4 by the first and second state detecting circuits 6, 8 and calculates a temperature deviation in a comparison of temperatures detected corresponding to the secondary battery packs 3, 4 by the first and second state detecting circuits 6, 8, and performs current limitation by comparing the calculated current ratio with a judgment value for the current ratio determined from the calculated temperature deviation.

Therefore, the control circuit 12 detects abnormality from the temperature difference and the current ratio to prevent overdischarging and overcharging. Further, the control circuit 12 can detect presence of abnormality regarding overdischarging, overcharging, deterioration, and internal short-circuit of the secondary battery packs, and can identify a secondary battery pack having abnormality. That is, the control circuit 12 can correspond to complex factors such as a factor due to abnormality of the secondary battery packs and an environmental factor due to that the secondary battery packs receive heat from the outside.

Further, in the third embodiment, similarly to the first and second embodiments, a supply fan 13 which cools the secondary battery packs 3, 4 is provided in the control system 2 for the parallel battery connection circuit. The control circuit 12 drives the supply fan 13 when the magnitude of deviation is judged.

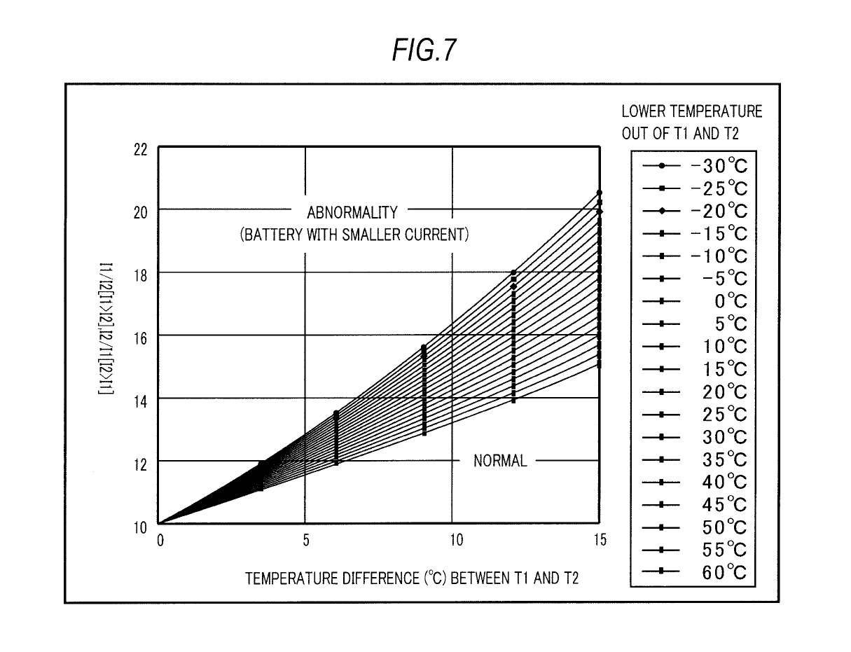

Then, when the control circuit 12 drives the supply fan 13, the temperature difference of the first and second secondary battery packs 3, 4 becomes small, and the temperature difference on the horizontal axis illustrated in FIG. 7, which will be described later, shifts leftward. The influence of the temperatures of the first and second secondary battery packs 3, 4 themselves can be made small, and accuracy can be assured while suppressing the number of status levels.

Therefore, in the control system 2 for the parallel battery connection circuit, the influence of environmental temperatures which vary easily by a mounting structure, arrangement, and the like of the first and second secondary battery packs 3, 4 is reduced, and thus accuracy can be improved.

Moreover, in the third embodiment, similarly to the first and second embodiments, a status level is set for the current limitation, and the control circuit 12 changes the driving level of the supply fan 13 according to the status level of the current limitation.

Therefore, the control circuit 12 can increase accuracy gradually according to the degree of the status.

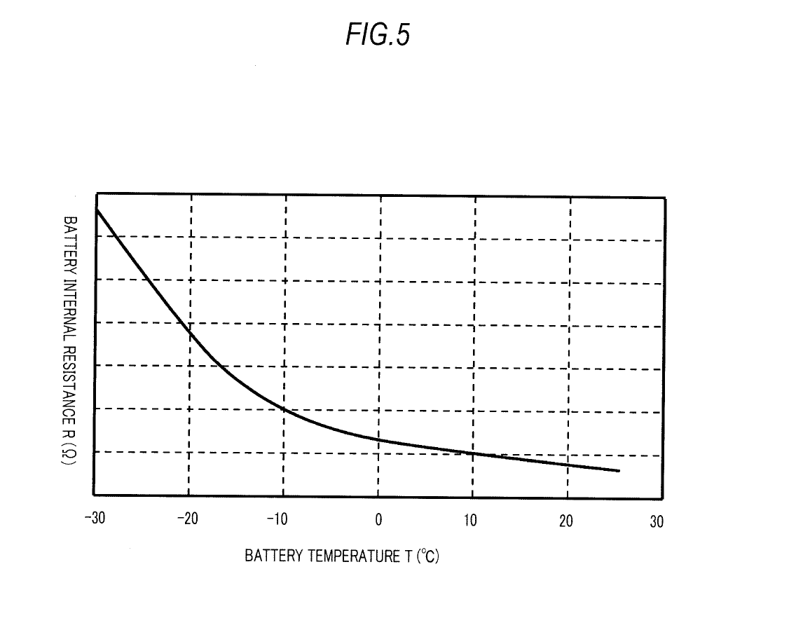

In addition, generally, internal resistances in the first and second secondary battery packs 3, 4 become higher as their temperatures become lower, and have a characteristic as illustrated in FIG. 5. FIG. 5 is a diagram illustrating the relation between a battery temperature and a battery internal resistance.

Here, an internal resistance R can be represented by following Equation 1.

[Equation 1]

R=10̂(A×1/(T+273)−B) Equation 1
R: battery internal resistance, T: battery temperature, and A, B: constant

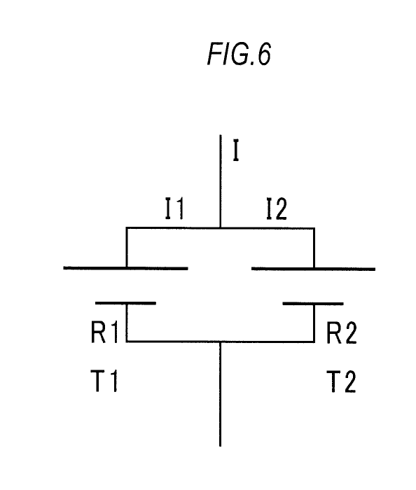

For reference, a schematic circuit diagram of a parallel battery, namely, the first and second secondary battery packs 3, 4 is disclosed in FIG. 6.

In FIG. 6,
I: inverter current,
I1: first battery current,
I2: second battery current,
R1: first battery internal resistance,
R2: second battery internal resistance,
T1: first battery temperature, and
T2: second battery temperature.

Here, the relation of the currents: I=I1+I2, and
the relation of the currents and the internal resistances: I1/I2=R2/R1.

In the schematic circuit diagram of FIG. 6, the currents flowing through the first and second secondary battery packs 3, 4 are inversely proportional to the internal resistances. Utilizing this, the control circuit 12 judges abnormality based on a judgment criterion of current ratio (I1/I2) obtained from a temperature difference (T1−T2) of the batteries.

Judgment lines by temperature at this point, which are judgment criteria with the battery temperature difference and the current ratio, are disclosed in FIG. 7. In FIG. 7, the horizontal axis represents the temperature difference, the horizontal axis represents the current ratio, and plural judgment lines are illustrated. The judgment lines are set corresponding to lower temperatures of the first and second secondary battery packs 3, 4.

Next, operation will be described along a control flowchart of the control system 2 for the parallel battery connection circuit of FIG. 4.

First, the control circuit 12 of the control system 2 for the parallel battery connection circuit executes a control program to start the control flowchart (301), starting the current limitation.

First, the control circuit 12 starts to detect the current and temperature of the first secondary battery pack 3 and starts to detect the current and temperature of the second secondary battery pack 4 via the first and second state detecting circuits 6, (302).

Next, the control circuit 12 sets the status level of the inverter current limitation to “0” (303).

Next, the control circuit 12 sets the current limitation of the inverter 10 to an initial value (304).

Next, the control circuit 12 calculates the temperature difference and the current ratio (305).

Next, the control circuit 12 determines whether or not the current ratio exceeds the judgment lines disclosed in FIG. 7 (306).

When this determination (306) is NO, the control circuit 12 returns to the above-described processing (303) and sets the status level of the inverter current limitation to “0” (303).

On the other hand, when the determination (306) is YES, the control circuit 12 sets the driving level of the supply fan 13 to “1” (307).

After the processing (307) of setting the driving level of the supply fan 13 to “1”, the control circuit 12 calculates the temperature difference and the current ratio again (308), and determines whether or not the current ratio exceeds the judgment lines disclosed in FIG. 7 (309).

When this determination (309) is NO, the control circuit 12 returns to the above-described processing (303) and sets the status level of the inverter current limitation to “0” (303).

On the other hand, when the determination (309) is YES, the control circuit 12 sets the status level of the inverter current limitation to “1” (310).

Next, the control circuit 12 decreases the current limitation of the inverter 10 by half (311).

Next, the control circuit 12 calculates the temperature difference and the current ratio again (312), and determines whether or not the current ratio exceeds the judgment lines disclosed in FIG. 7 (313).

When this determination (313) is NO, the control circuit 12 returns to the above-described processing (302) and starts to detect the currents and temperatures of the first and second secondary battery packs 3, 4 via the first and second state detecting circuits 6, 8 (302).

On the other hand, when the determination (313) is YES, the control circuit 12 sets the driving level of the supply fan 13 to “2” (314).

After the processing (314) of setting the driving level of the supply fan 13 to “2”, the control circuit 12 calculates the temperature difference and the current ratio again (315), and determines whether or not the current ratio exceeds the judgment lines disclosed in FIG. 7 (316).

When this determination (316) is NO, the control circuit 12 returns to the above-described processing (310) and sets the status level of the inverter current limitation to “1” (310).

On the other hand, when the determination (316) is YES, the control circuit 12 sets the status level of the inverter current limitation by temperature difference to “2” (317).

Next, the control circuit 12 sets the current limitation of the inverter to “0A” (318).

Note that the present invention is not limited to the above-described first to third embodiments, and various applications and modifications are possible.

For example, the first embodiment of the present invention is structured such that the control circuit 12 calculates a current difference of the first and second secondary battery packs 3, 4 and, when the current difference exceeds the predetermined judgment value, increments the status of limiting a driving current of the inverter 10 by complying with the current limitation map of [Table 1] and limits the current of the inverter 10 by complying with this limitation. Further, the second embodiment is structured such that the control circuit 12 calculates a temperature difference of the first and second secondary battery packs 3, 4 and, when the temperature difference exceeds a predetermined judgment value, increments the status of limiting the driving current of the inverter 10 by complying with the current limitation map of [Table 2] and limits the current of the inverter by complying with this limitation. Without being limited to these embodiments, it is also possible to employ a special structure such that the control circuit 12 takes a voltage difference of the first and second secondary battery packs 3, 4 into consideration.

Specifically, when a difference occurs in the voltages of the first and second secondary battery packs 3, 4 before the ignition is turned on, the control circuit 12 controls the relays by complying with an inverter current limitation map by battery voltage difference before the ignition is turned on, which is illustrated in [Table 3] below. For example, when the temperature difference of the first and second secondary battery packs 3, 4 is less than or equal to 30(° C.), the control circuit 12 turns on the relays 7, 9 as usual. Further, when the temperature difference is more than 30(° C.) and less than or equal to 50(° C.), the control circuit 12 does not turn on the relays 7, 9. Note that the control circuit 12 may turn on only the relay 7, 9 corresponding to the first and second secondary battery pack 3, 4 with a smaller voltage.

TABLE 3
Inverter current limitation map by battery
voltage difference before IG-ON

| Status | 0 | 1 |
|---|---|---|
| ΔT(° C.) | 30 or less | 30 to 50 |
| Current | Normal relay | Relay is not |
| limitation | turning on | turned on |

Further, for the current limitation by using [Table 1] of the first embodiment and the current limitation by using [Table 2] of the second embodiment, there are predetermined limit values set in advance, and when the level of the status changes, a ratio change with respect to the predetermined current limitation is made.

For example, a predetermined limit value becomes the current limitation without being changed at the status “0”, a half of the predetermined limit value becomes the current limitation at the status “1”.

The stop means to set the current limitation to “0”.

Moreover, the supply fan 13 can be provided separately to each of the plurality of secondary battery packs 3, 4, and when it is provided separately, the driving control may be performed so that the plurality of secondary battery packs can be cooled uniformly.

Furthermore, in the first to third embodiments of the present invention, although the status levels of the inverter current limitation are provided in three stages of “0” to “2”, it is also possible to employ a special structure of finely dividing this status level to increase the number of levels.

By increasing the number of levels, the inverter current limitation can be performed finely in a finely divided status levels, which can contribute to improvement of current limitation accuracy.

Further, in the first embodiment of the present invention, the structure is described in which the state detecting circuits 6, 8 and the relays 7, 9 are accommodated in the secondary battery packs 3, 4, but it is also possible to employ a structure in which the state detecting circuits and the relays are provided separately.

Note that although a detailed description is omitted, it is also possible to employ a structure in which the state detecting circuits and the relays are accommodated in a DC/DC converter, a junction box, or the like which is provided together with the battery unit.

Moreover, in the present invention, the first embodiment utilizing the current difference and the second embodiment utilizing the temperature difference are described as separate embodiments, but it is also possible to use both the first embodiment utilizing the current difference and the second embodiment utilizing the temperature difference together, and a change such as combining either of them with priority may be added, so as to make a new embodiment.

### INDUSTRIAL APPLICABILITY

The present invention can be used for an electrically powered vehicle having a battery as a driving energy source, such as an electric vehicle (also called “EV”), a hybrid vehicle (also called “HEV”), or a plug-in hybrid vehicle (also called “PHEV”).

1. A control system for a parallel battery connection circuit having a plurality of secondary battery packs connected in parallel to each other, in which small batteries are combined and provided substantially equivalently to each other, and performing abnormality detection by detecting and comparing states of the secondary battery packs, the control system comprising:
state detecting circuits which detect currents or temperatures and are provided respectively in the secondary battery packs; and
a control circuit which performs current limitation based on a magnitude of deviation between a deviation in either of a comparison of currents detected corresponding to the secondary battery packs by the state detecting circuits or a comparison of temperatures detected corresponding to the secondary battery packs by the state detecting circuits, and a predetermined judgment value.

2. The control system for the parallel battery connection circuit according to claim 1, further comprising a supply fan which cools the secondary battery packs,
wherein the control circuit drives the supply fan accompanying the judgment of the magnitude of deviation.

3. The control system for the parallel battery connection circuit according to claim 2,
wherein the control circuit sets a status level to the current limitation, and changes a driving level of the supply fan according to the status level of the current limitation.

4. A control system for a parallel battery connection circuit having a plurality of secondary battery packs connected in parallel to each other, in which small batteries are combined and provided substantially equivalently to each other, and performing abnormality detection by detecting and comparing states of the secondary battery packs, the control system comprising:
state detecting circuits which detect currents and temperatures and are provided respectively in the secondary battery packs; and
a control circuit which calculates a current ratio from currents detected corresponding to the secondary battery packs by the state detecting circuits and calculates a temperature deviation in a comparison of temperatures detected corresponding to the secondary battery packs by the state detecting circuits, and performs current limitation by comparing the calculated current ratio with a judgment value for the current ratio determined from the calculated temperature deviation.

5. The control system for the parallel battery connection circuit according to claim 4, further comprising a supply fan which cools the secondary battery packs,
wherein the control circuit drives the supply fan accompanying a comparison result of the calculated current ratio with the judgment value.

6. The control system for the parallel battery connection circuit according to claim 5,
wherein the control circuit sets a status level to the current limitation, and changes a driving level of the supply fan according to the status level of the current limitation.
